(19) United States
(12) Patent Application Publication
(10) Pub. No.: US 2023/0386358 A1
(43) Pub. Date: Nov. 30, 2023

(54) READING TOOL

(71) Applicant: Katherine MCKENZIE, Northampton (GB)

(72) Inventor: Katherine MCKENZIE, Northampton (GB)

(21) Appl. No.: 18/250,271

(22) PCT Filed: Oct. 18, 2021
(86) PCT No.: PCT/EP2021/078767

§ 371 Date: Apr. 24, 2023

(30) Foreign Application Priority Data
Oct. 26, 2020 (GB) 2016938.9

(51) Int. Cl. G09B 17/02

(52) U.S. Cl. CPC G09B 17/02

(57) ABSTRACT

A reading device for helping to learn to read comprises a body (2) have an elongated through opening forming a reading window (3). The window (3) is sized and shaped to enable at least a part of a single row of reading text to be displayed in the window (3). A panel (4) is moveably mounted on the body (2) so as to be longitudinally movable relative to the body (2) so as to variably overlap the window (3) from one side in order to restrict the width of the window (3) and thereby obscure some of the text aligned with the window (3).

### BACKGROUND OF THE INVENTION

### 1. Field of Invention

The present relates to devices to aid in teaching how to read.

### 2. The Prior Art

When learning to read and write in school, children initially learn through phonics, which are the sounds (phonemes) which individual or combinations of letters make, that when blended together produce words. Initially the most common phonics are taught in isolation (m, s, a, h etc.), and then, once these are known and recognized, the student moves on to connecting the different phonics together as they appear in words to build up the sounds of the word.

However, when moving on to reading full words—and in particular progressively bigger words, students can find it difficult to make the transition from knowing and recognizing individual phonemes to being able to identify and recognize the individual phonemes when they grouped together with other phonemes within a word.

There is accordingly a need for a device which helps a student to break down words into the individual phonemes so as to help develop reading skills.

### SUMMARY OF THE INVENTION

According to the present invention there is provided a reading device for helping to learn to read, comprising a body have an elongated through opening forming a reading window which is sized and shaped to enable at least a part of a single row of reading text to be displayed in the window, a single moveable panel slideably mounted on the body in longitudinal alignment with the window such that it can slide longitudinally across the window from one longitudinal side of the window towards the other to variably overlap the window selectively to partially or completely close the window and hence at least partially obscure the underlying text aligned with the window, a fixed panel on the other side of the window remote from the moveable panel, said fixed panel acting as a stop to limit the movement of the moveable panel beyond the window, and an arm associated with and attached to each panel at a first end, the arms being attached together at their second ends opposite the first ends and remote from the panels in the manner of a tong/tweezer, whereby movement of the or each moveable panel can be effected by means of the arms.

The reading device according to the invention has the advantage that it enables words to be broken down by moving the at least one panel to restrict the portion of a work displayed in the window to just an individual phoneme, allowing the individual phonemes within a word to be displayed separately so help the student to identify each one, before being built up together to reveal the word. This helps words (segments) to be broken down easily and effectively during a reading session—whether this be in, for example, a school, at home etc. The device of the invention enables the phonemes within words or sections of words to be isolated so the reader can more easily see the individual building blocks in the words working in practice, blend more confidently, and ultimately support their early reading experience.

The fixed panel may be integrally formed. The fixed panel preferably extends only partially across the width of the body and is spaced from either longitudinal side so as to define a longitudinal channel on either side of the fixed panel. The moveable panel optionally then has a pair of spaced apart longitudinally extending fingers which extend from the moveable panel towards the fixed panel on either side of the window, the fingers being sized and positioned to engage in the channels on either side of the fixed panel to guide the sliding movement of the moveable panel.

Locking means may be associated with the or each moveable panel such that the or each panel can be locked in position.

The height of the window may be variable to accommodate text of different heights.

The arms are preferably biased away from each other such that the moveable panel is biased away from the fixed panel and into a position in which it is completely withdrawn from the window and the window is fully open.

### BRIEF DESCRIPTION OF THE DRAWINGS

In order that the invention may be well understood, there will now be described an embodiment therefore, given by way of example, reference being made to the accompanying drawings, in which:

FIG. 1 is a side view of a reading device according to the invention;

FIG. 2 is an exploded side view of the device of FIG. 1;

FIG. 3 is a side view of the device of FIG. 1 in a first operational configuration; and

FIG. 4 is a side view of the device of FIG. 1 in a second operational configuration.

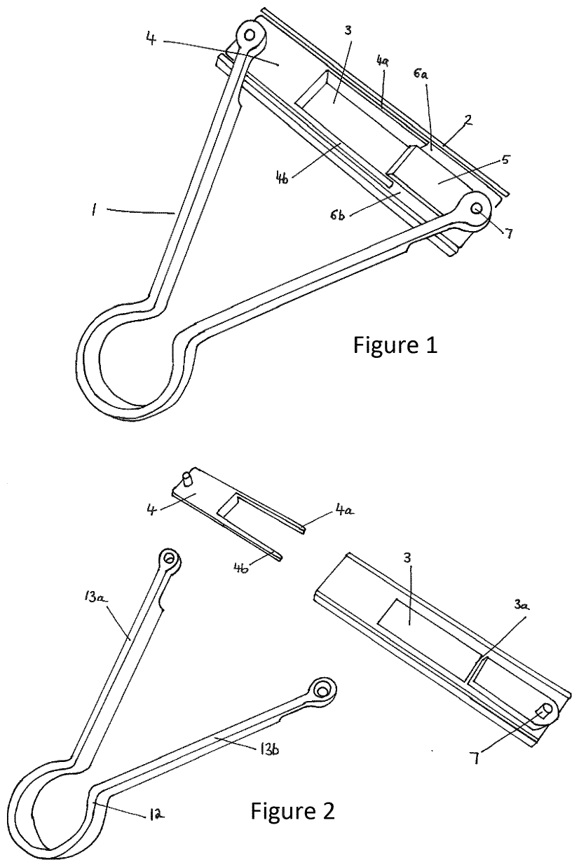

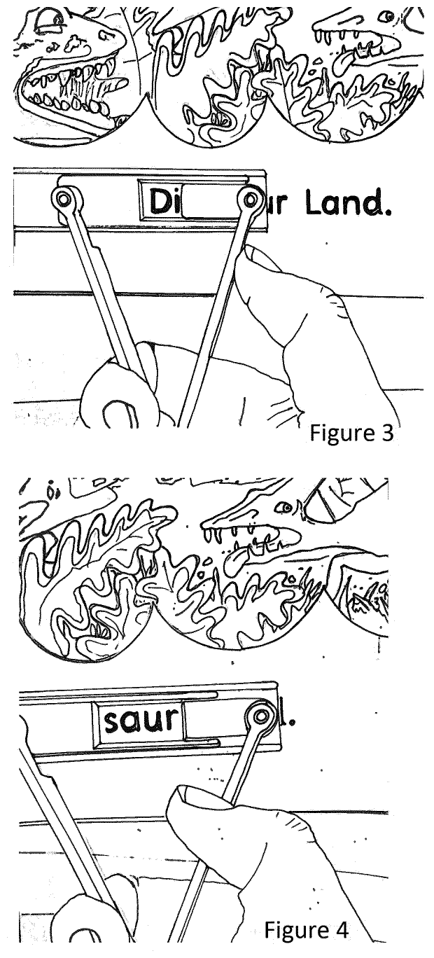

### DETAILED DESCRIPTION OF THE PREFERRED EMBODIMENTS

Referring first to FIG. 1, there is shown a side view of a reading device 1 of the invention. The device 1 has an elongated rectangular body 2 with a rectangular window 3 formed therein which forms a reading window as set out below. Extending along each longitudinal side of the body 2 is a flange 2a, 2b which upstands from the longitudinal face of the body. At one end 3a of the window 3 is formed a fixed panel 5, the fixed panel 5 being narrower than the width of the body such that it is spaced apart, on either longitudinal side, from the flanges 2a, 2b such that a channel 6a, 6b is defined on either side of the fixed panel 5 between the fixed panel 5 and the flanges 2a, 2b. A locating peg 7 is formed on the fixed panel 5 for locating a connecting arm 13a of an actuator 12 as discussed below.

The device 1 furthermore includes a moveable panel 4 which locates on the body 2 between the flanges 2a, 2b so as to be slideable along the face of the body 2 towards and away from the fixed panel 5. The moveable panel 4 has a spaced apart pair of guide fingers 4a, 4b extending longitudinally from its end which faces the fixed panel 5, the fingers 4a, 4b being sized to extend along either longitudinal side of the window 3 and locate in the channels 6a, 6b. Like the fixed panel, the moveable panel 6 also has a locating peg 8 on its outer face for locating a connecting arm 13b of the actuator 12.

The pair of connecting arms 13a, 13b of the actuator 12 extend in a V configuration from a connecting arc 13c, the connecting arc 13c being resiliently deformable such that the arms 13a, 13b can be pressed towards each other. Each connecting arm 13a, 13b has a locating eye 14a, 14b on its free end, each eye 14a, 14b being engageable onto the locating peg 7, 8 of one of the panels so as to fasten the arms 13a, 13b to the panels 4, 5. In this way, when the arms 13a, 13b are pressed towards each other, the moveable panel 4 is caused to slide along body 2 and across the window 3, overlapping the window 3 so as to reduce the width thereof. The fixed panel 5 acts as a stop for the moveable panel 4. Upon release pressure from the arm, the connecting arc 13c biases the arms 13a, 13b away from each other and the moveable panel 4 away from the fixed panel 5 such that it uncovers the window 3.

The device is used as follows:

The body 2 is positioned on a page of text with the window 3 aligned with a portion of the text such as an individual word which it is desired to read so that the text or word is visible in the window. Using the arms 13a, 13b, the moveable panel 4 is then moved across the window to conceal portions of the word or text so that just a single phoneme is visible therein as shown in FIG. 4, helping the reader to identify and sound that phoneme. Once that phoneme has been identified and sounded, the device is either moved to the next phoneme or the window extended by allowing the moveable panel 4 to move back to reveal the neighboring letter or letters. In this way, the reader can easily build the word until the whole word has been sounded.

1. A reading device for helping to learn to read, comprising a body have an elongated through opening forming a reading window which is sized and shaped to enable at least a part of a single row of reading text to be displayed in the window, a single moveable panel slideably mounted on the body in longitudinal alignment with the window such that it can slide longitudinally across the window from one longitudinal side of the window towards the other to variably overlap the window selectively to partially or completely close the window and hence at least partially obscure the underlying text aligned with the window, a fixed panel on the other side of the window remote from the moveable panel, said fixed panel acting as a stop to limit the movement of the moveable panel beyond the window, and an arm associated with and attached to each panel at a first end, the arms being attached together at their second ends opposite the first ends and remote from the panels in the manner of a tong/tweezer, whereby movement of the or each moveable panel can be effected by means of the arms.

2. The reading device according to claim 1, wherein the fixed panel extends only partially across the width of the body and is spaced from either longitudinal side so as to define a longitudinal channel on either side of the fixed panel.

3. The reading device according to claim 2, wherein the moveable panel includes a pair of spaced apart longitudinally extending fingers which extend from the moveable panel towards the fixed panel on either side of the window, the fingers being sized and positioned to engage in the channels on either side of the fixed panel to guide the sliding movement of the moveable panel.

4. The reading device according to claim 1, further including locking means associated with the or each moveable panel such that the or each panel can be locked in position.

5. The reading device according to claim 1, wherein, the height of the window is dimensioned to accommodate the height of one line of text.

6. The reading device according to claim 1, wherein the arms are biased away from each other such that the panels are fully open in an unbiased state.

7. A reading device for concealing portions of a word to assist in reading comprising:
a body have an elongated rectangular through opening forming a reading window which is sized and shaped to enable at least a part of a single row of a reading text to be displayed in the window and a channel extending parallel to a long side of the window;
a single moveable panel having an arm slideably mounted within the channel in longitudinal alignment with the window such that it can slide longitudinally across the window from a first short side of the window towards a second short side to variably overlap the window to partially or completely close the window and hence at least partially obscure the underlying text aligned within the window;
said body further including a fixed panel adjacent the second short side of the window acting as a stop to limit the movement of the moveable panel beyond the window; and
an arm attached to each panel at a first end, the arms being flexibly attached together at their second ends opposite the first ends and remote from the panels so that the first end of the arms can be moved toward and away from each other to selectively slide the movable panel and displace the fixed panel to conceal different portions of a word.
